(19) United States
(12) Patent Application Publication
(10) Pub. No.: US 2016/0347105 A1
(43) Pub. Date: Dec. 1, 2016

(54) ORNAMENT PIECE AND MANUFACTURE METHOD

(71) Applicants: SHENZHEN FUTAIHONG PRECISION INDUSTRY CO., LTD., Shenzhen (CN); FIH (HONG KONG) LIMITED, Kowloon (HK)

(72) Inventors: YU-TSAI WANG, New Taipei (TW); XIAO-FAN ZHANG, Shenzhen (CN); LING MA, Shenzhen (CN)

(21) Appl. No.: 14/806,300

(22) Filed: Jul. 22, 2015

(30) Foreign Application Priority Data
May 25, 2015 (CN) 201510269567.3

(51) Int. Cl. B41M 5/26; B41M 5/34; B41M 5/385

(52) U.S. Cl. CPC B41M 5/262; B41M 5/385; B41M 5/345; B41M 2205/06; B41M 2205/08; B41M 2205/02

(57) ABSTRACT

An ornament piece includes a base and a pattern layer formed on at least one surface of the base. The pattern layer includes at least one pattern. The at least one pattern is formed on the surface of the base by carbon powder with colors different from that of the base and infiltrating into the surface of the base. A manufacture method of the ornament piece is also provided.

### FIELD

The subject matter herein generally relates to an ornament piece and a manufacture method of the ornament piece.

### BACKGROUND

Appearances of electronic devices are more and more important nowadays. Ornament pieces of the electronic devices are usually made of martial, such as glasses, aluminum, or aluminum alloy, with simplex color. The ornament pieces may be extra manufactured, printing or plating for example, to be multiple color or more colorful. However, the traditional manufacture processes are complicated and may course some pollution. Therefore, the ornament pieces with multiple colors and simple manufacture process still need to be improved in the art.

### BRIEF DESCRIPTION OF THE DRAWINGS

Many aspects of the disclosure can be better understood with reference to the following figures. The components in the figures are not necessarily drawn to scale, the emphasis instead being placed upon clearly illustrating the principles of the disclosure. Moreover, in the drawings, like reference numerals designate corresponding parts throughout the several views.

FIG. 1 is a diagrammatic view of an exemplary embodiment of an ornament piece.

FIG. 2 is cross-sectional view of the ornament piece of FIG. 1 along line II-II.

FIG. 3 is a cutaway view of an exemplary embodiment of a laser paper of a manufacture method of the ornament piece.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series and the like.

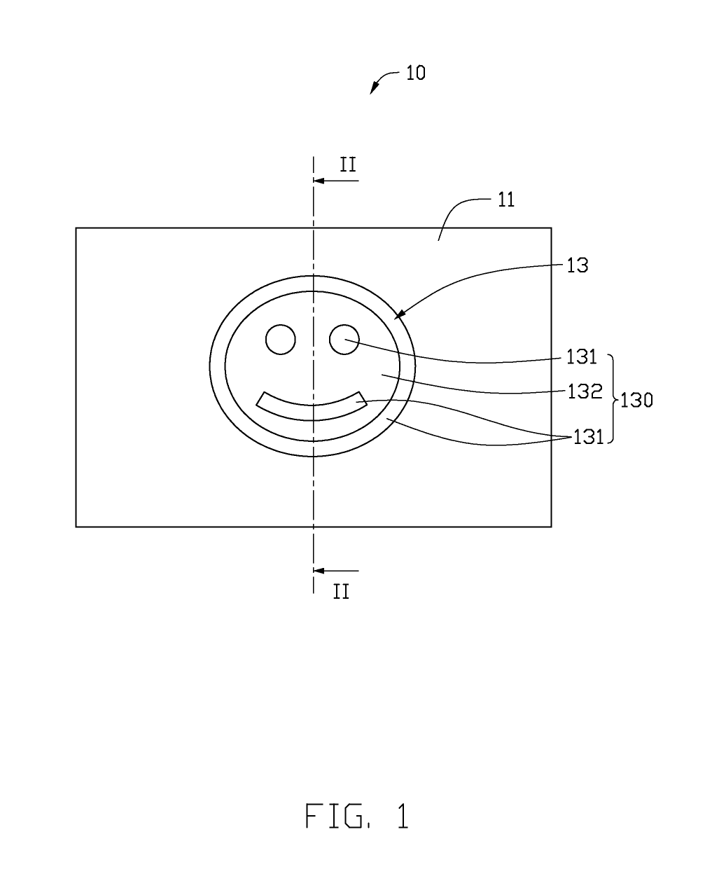

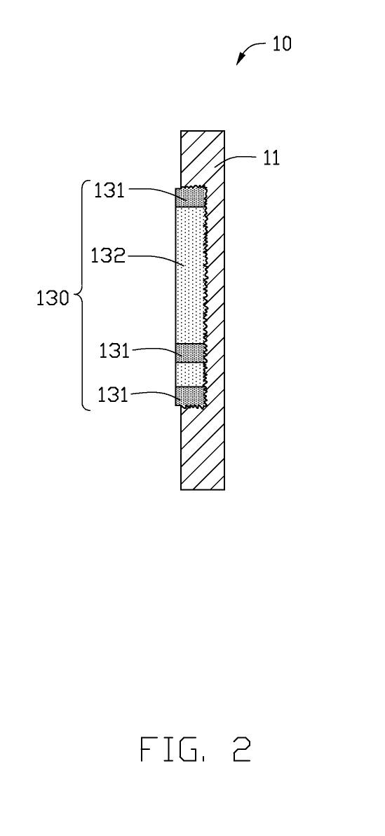

FIGS. 1 and 2 illustrate an exemplary embodiment of an ornament piece 10. The ornament piece 100 includes a base 11 and a pattern layer 13 formed on the base 11.

The base 11 can be made of glasses or metal material, such as aluminum or aluminum alloy. The base 11 can be an appearance piece, a case for example, of an electronic device for providing patterns designs.

The pattern layer 13 is formed on at least one surface of the base 11. The pattern layer 13 includes at least one pattern 130. Each pattern 130 includes at least one color zone. The at least one color zone is divided by color, portions of the pattern 130 with a same color are regarded as a same color zone, each color zone has a color different from a color of the base 11. In one embodiment, the pattern layer 13 includes one pattern 130, the pattern 130 includes a first color zone 131 and a second color zone 132, the first color zone 131 and the second color zone 132 cooperatively form a integrate pattern. The first color zone 131 has a first color and the second color zone 132 has a second color that is different from the first color. Thus, the pattern 130 is multiple colors. The pattern 130 is formed by laser marking, that is, the first color zone 131 is formed by infiltrating carbon powder with a first color into the surface of the base 11, the second color zone 132 is formed by infiltrating carbon powder with a second color into the surface of the base 11.

A manufacture method of the ornament piece 10 is described as follows:

Providing a base 11 made of glasses or metal material, such as aluminum or aluminum alloy. In one embodiment, the base 11 is made of aluminum.

Processing surface treatment to the base 11. In detail, anodizing the base 11 to form an oxidation firm on the surface of the base, the oxidation firm forms several tiny holes (not shown). In another embodiment, the base 11 is made of glass, cleaning the base 11 is processed instead.

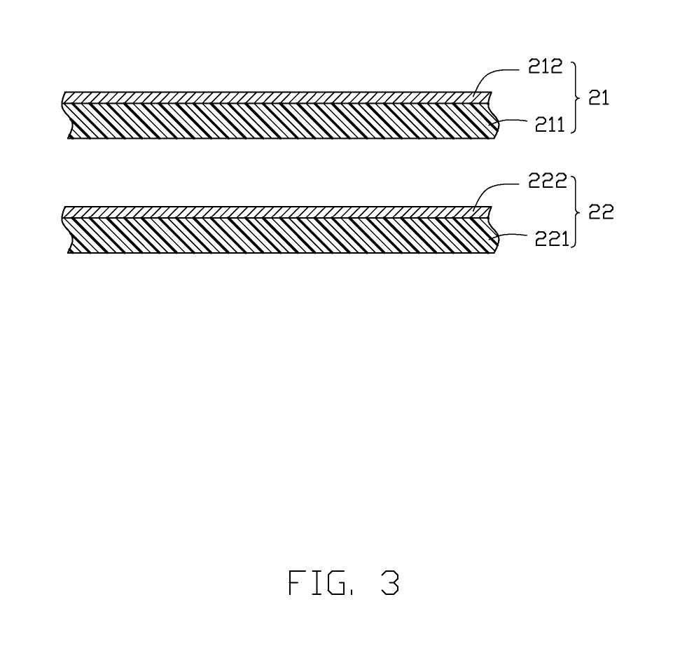

FIG. 3 illustrates that providing at least one laser paper. In one embodiment, two laser papers are provided, which includes a first laser paper 21 and a second laser paper 22. The first laser paper 21 includes a first carrier 211 and a first film 212 formed on the first carrier 211. The first film 212 has a first color. The second laser paper 22 includes a second carrier 221 and a second film 222 formed on the second carrier 221. The second film 222 has a second color. The first film 212 and the second film 222 can be made of carbon powder material.

Immersing separately the first laser paper 21 and the second laser paper 22 in purified water in different containers to make the first film 212 separate from the first carrier 211 and the second film 222 separate from the second carrier 221.

Attaching seamlessly the first film 212 to the surface of the base 11. In detail, attaching the first film 212 by a holding tool, such as a nipper, to a zone that needs to form the pattern 130 of the base 11.

Airing the first film 212 on the base 11 in nature environment to dry the first film 212.

Laser marking the first film 212. The first film 212 infiltrates into the surface of the base 11 by the laser marking to form the first color zone 131. In detail, presetting a figure in a laser device (not shown), the figure is formed on the first film 212 by laser marking. Adjusting an energy range of about 5-10 Watt (W), a laser marking velocity of about 100-300 mm/s, and a frequency range of about 50-100 KHz. Thus, the laser device emits high energy laser through the first film 212 and the surface of the base 11 to make the temperature thereof up to 500-600° C., the carbon powder of the first film 212 infiltrates into the surface of the base 11 to form the first color zone 131. Therefore, the first color zone 131 includes the color of the first film 212.

Removing portions of the first film 212 that beyond the figure from the base 11. In detail, cleaning the base 11 in ethyl alcohol to removing the portions of the first film 212 beyond the figure.

Attaching seamlessly the second film 222 to the surface of the base 11. In detail, attaching the second film 222 by the holding tool, such as the nipper, to a zone that needs to form the pattern 130 of the base 11.

Airing the second film 222 on the base 11 in nature environment to dry the second film 222.

Laser marking the second film 222. The second film 222 infiltrates into the surface of the base 11 by the laser marking to form the second color zone 132. In detail, another figure is formed on the second film 222 by laser marking. Adjusting an energy range of about 5-10 Watt (W), a laser marking velocity of about 100-300 mm/s, and a frequency range of about 50-100 KHz. Thus, the laser device emits high energy laser through the second film 222 and the surface of the base 11 to make the temperature thereof up to 500-600° C., the carbon powder of the second film 222 infiltrates into the surface of the base 11 to form the second color zone 132. Therefore, the second color zone 132 includes the color of the second film 222.

Removing portions of the second film 222 that beyond the figure from the base 11. In detail, cleaning the base 11 in ethyl alcohol to removing the portions of the second film 222 beyond the figure.

In other embodiments, when the ornament piece 10 only forms the first color zone 131 of the pattern 130, the manufacture process of forming the second color zone 132 can be omitted.

In other embodiments, when the ornament piece 10 needs to form three or more color zones on the base 11, repeat extra manufacture processes as that of forming the first color zone 131 or forming the second color zone 132. In each extra manufacture process, providing a laser paper with a color different from the colors of the laser papers in former manufacture processes.

The ornament piece 10 forms the pattern 130 with multiple colors on the base 11 by laser marking Each color of the pattern 130 is formed by laser marking, which is a simple manufacture process, and it's great efficiency by repeating the manufacture processes of forming every color of the pattern 130.

It is believed that the embodiments and their advantages will be understood from the foregoing description, and it will be apparent that various changes may be made thereto without departing from the scope of the disclosure or sacrificing all of its advantages, the examples hereinbefore described merely being illustrative embodiments of the disclosure.

What is claimed is:

1. An ornament piece comprising:
a base; and
a pattern layer formed on at least one surface of the base, the pattern layer comprising at least one pattern;
wherein the at least one pattern is formed on the surface of the base by carbon powder with colors different from that of the base and infiltrating into the surface of the base.

2. The ornament piece as claimed in claim 1, wherein the pattern comprises at least one color zone, the at least one color zone is divided by color, portions of the pattern with a same color are regarded as a same color zone, a same color zone is formed by infiltrating carbon powder with a same color to the surface of the base; different color zones are formed by infiltrating carbon powder with different colors to surface of the base.

3. The ornament piece as claimed in claim 2, wherein the at least one color zone is formed by laser marking

4. The ornament piece as claimed in claim 1, wherein the base is made of glass or metal material, the metal material is aluminum or aluminum alloy.

5. A manufacture method of an ornament piece comprising:
providing a base and at least one film having a color different from that of the base;
attaching the at least one film to at least one to at least one surface of the base;
airing the at least one film;
laser marking the film to infiltrate a predetermined figure of the film into the surface of the base to form a pattern; and
removing portions of the film that beyond the figure from the base to finish manufacturing the ornament piece.

6. The manufacture method as claimed in claim 5, further comprising repeating manufacture processes to form more than one color zones of the pattern, wherein providing films with colors different from that of the films in former manufacture processes.

7. The manufacture method as claimed in claim 5, wherein providing the at least one film comprising:
providing at least one laser paper comprising a carrier and the film formed on the carrier;
immersing the at least one laser paper in purified water to make the film separate from the carrier.

8. The manufacture method as claimed in claim 5, further comprising processing surface treatment of the base, wherein anodizing the base to form an oxidation firm on the surface of the base, the oxidation firm forms several tiny holes.

9. The manufacture method as claimed in claim 5, wherein the base is made of glasses or metal material, the metal material is aluminum or aluminum alloy.

10. The manufacture method as claimed in claim 5, wherein the film is made of carbon powder.

11. The manufacture method as claimed in claim 10, further comprising:
presetting the predetermined figure in a laser device;
adjusting an energy range of about 5-10 Watt, a laser marking velocity of about 100-300 mm/s, and a frequency range of about 50-100 KHz.
